(19) United States
(12) Patent Application Publication
(10) Pub. No.: US 2013/0330017 A1
(43) Pub. Date: Dec. 12, 2013

(54) PHASE SHIFT REDUCTION IN TOUCH SIGNALS

(71) Applicant: John Greer ELIAS, Townsend, DE (US)

(72) Inventor: John Greer ELIAS, Townsend, DE (US)

(21) Appl. No.: 13/490,386

(22) Filed: Jun. 6, 2012

(51) Int. Cl. G06K 9/40; G06G 7/12

(52) U.S. Cl. 382/254; 327/355

(57) ABSTRACT

Phase shift reduction in touch signals is disclosed. Touch signals with phase shifts can be demodulated with I- and Q-demodulation waveforms to generate the I and Q components of the signals. The I and Q components can then be combined so as to provide magnitude information not affected by the phase of the touch signals. The touch signals can be reconstructed with the combined I and Q components, thereby providing reconstructed touch signals with little or no phase shift.

### FIELD

This relates generally to touch signals and more specifically to reducing phase shifts in touch signals.

### BACKGROUND

FIG. 1 illustrates an exemplary touch panel for capturing touch signals indicative of an object's proximity to the panel. In the example of FIG. 1, touch panel 100 can include rows 101 and columns 102 that cross each other to form touch regions 124 for sensing a proximate object. During a scan of the panel to sense the proximate object, the rows 101 can be driven by drive circuitry (not shown) with stimulation signals V to form touch signals R at the touch regions 124 along the driven rows. The stimulation signals V can be either a positive (+) phase stimulation signal V+ or a negative (−) phase stimulation signal V− having the same waveform as V+ inverted about a common voltage. For example, the first row 101 can form a touch signal R₁ at the touch regions 124 along that row. The touch signals R can be a function of the stimulation signal V and the capacitance C_{sig} formed between the rows 101 and crossing columns 102.

The columns 102 can then transmit the touch signals R from the corresponding touch regions 124 along the columns to output sense signals S to sense circuitry (not shown) for further processing, thereby forming a touch image. For example, the first column 102 can transmit touch signals R₁, R₂, R₃, R₄ from the first through fourth crossing rows 101 to output sense signal S₁. The magnitudes of the touch signals R and sense signals S can be a function of the object's location and proximity to the panel, thereby providing location and proximity information for various operations of the panel 100.

Because the conductive material forming the rows 101 and columns 102 can be resistive with corresponding capacitance, the transmission of signals throughout the panel 100 can be interfered with, resulting in phase shifts in the touch signals R. For example, the touch signals R₁, R₂, R₃, R₄ for the first through fourth rows 101, respectively, can have different phases θ₁, θ₂, θ₃, θ₄, respectively, due to the resistance in the conductive material. Similarly, the sense signals S₁, S₂, S₃, S₄ outputted from the first through fourth columns 102, respectively, can have different phases which are a function of phases θ₁, θ₂, θ₃, θ₄, caused by the conductive material's resistance and capacitance.

These phase shifts can cause errors in the touch signals R, e.g., shifting the signal magnitudes, which can lead to inaccurate or erroneous object location and proximity information.

### SUMMARY

This relates to reducing phase shifts in touch signals utilizing in-phase (I) and quadrature phase (Q) components of the touch signals. To do so, touch signals with phase shifts can be demodulated with I- and Q-demodulation waveforms to generate the I and Q components of the signals. The I and Q components can then be combined so as to provide magnitude information not affected by the phase of the touch signals. The touch signals can be reconstructed with the combined I and Q components, thereby providing reconstructed touch signals with little or no phase shift. The ability to remove phase shifts in captured touch signals eliminates the need for panel calibration to account for the phase shifts or phase correction after processing the touch signals.

### BRIEF DESCRIPTION OF THE DRAWINGS

FIG. 1 illustrates an exemplary touch panel for capturing touch signals according to various embodiments.

FIG. 2 illustrates an exemplary method for reducing phase shifts in touch signals according to various embodiments.

FIG. 3 illustrates effects of various phase shifts on touch signals according to various embodiments.

FIG. 4 illustrates an exemplary computing system that can perform phase shift reduction according to various embodiments.

FIG. 5 illustrates an exemplary mobile telephone that can perform phase shift reduction according to various embodiments.

FIG. 6 illustrates an exemplary digital media player that can perform phase shift reduction according to various embodiments.

FIG. 7 illustrates an exemplary portable computer that can perform phase shift reduction according to various embodiments.

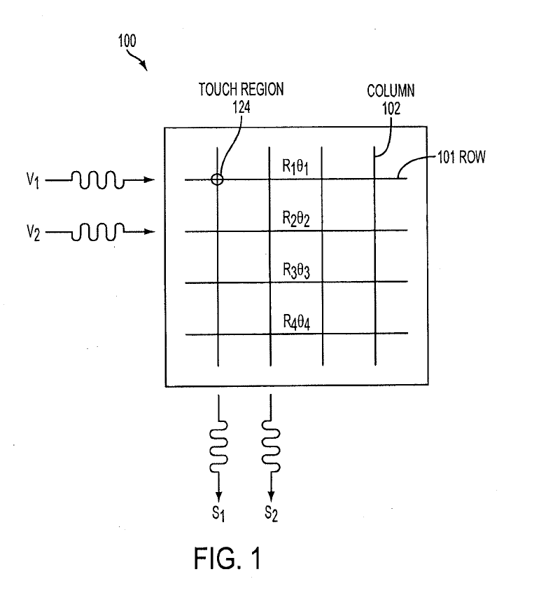

### DETAILED DESCRIPTION

In the following description of example embodiments, reference is made to the accompanying drawings in which it is shown by way of illustration specific embodiments that can be practiced. It is to be understood that other embodiments can be used and structural changes can be made without departing from the scope of the various embodiments.

This relates to reducing phase shifts in touch signals utilizing in-phase (I) and quadrature phase (Q) components of the touch signals. To do so, touch signals with phase shifts can be captured. The touch signals can be demodulated with I- and Q-demodulation waveforms to generate the I and Q components of the signals. The I and Q components can then be combined so as to provide magnitude information not affected by the phase of the touch signals. The captured touch signals can be reconstructed with the combined I and Q components, thereby providing reconstructed touch signals with little or no phase shift. The ability to remove phase shifts in captured touch signals eliminates the need for panel calibration pre-capture to account for the phase shifts or phase correction after processing the touch signals.

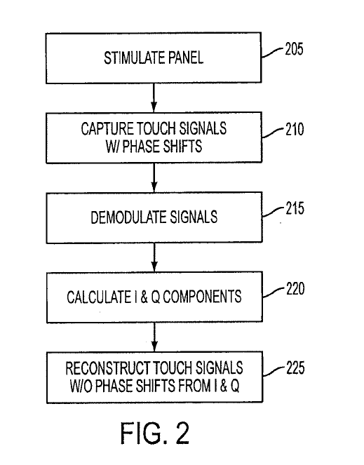

FIG. 2 illustrates an exemplary method for reducing phase shifts in touch signals according to various embodiments. In the example of FIG. 2, during a touch panel scan, the touch panel can be stimulated with stimulation signals in order to sense a proximate object (205). In some embodiments, multiple stimulation signals can be applied to the panel simultaneously to drive multiple panel rows. The stimulation signals V can include both V+ and V− signals depending on the desired scan pattern. In some embodiments, a single stimulation signal can be applied to the panel to drive one panel row at a time. The stimulation signal V can apply either a V+ or V− signal depending on the desired scan pattern.

Touch signals R along the panel rows can be generated and transmitted along the panel columns as sense signals S to sensing circuitry for further processing, thereby forming a touch image (210). Due to the resistance and capacitance in the conductive rows and columns of the panel, as described previously, the touch signals R can have phase shifts, which can subsequently appear in the sense signals S. The relationship between the sense signals S and the touch signals R with phase shifts can be formulated mathematically as follows.

S_{j,n}=A·Rᵢθᵢ, (1)

where i=ith row in the touch panel, j=jth column in the panel, n=nth drive step of the panel scan, and A=stimulation matrix that defines the scan pattern, including which rows are driven at which stimulation signal phase V+ or V− during which step n. Accordingly, the sense signal S_{j,n} outputted from column j of the panel during step n of the panel scan can be a function of the scan pattern in matrix A and touch signals R in driven rows i with their corresponding phase shifts θ.

As described previously, the phase shifts can adversely impact the touch panel, resulting in inaccurate or erroneous object location and proximity information. A method according to various embodiments can substantially reduce or eliminate the phase shifts by reconstructing the touch signals R with little or no phase shifts. First, the sense signals S can be demodulated into their in-phase (I) and quadrature phase (Q) components as follows (215).

SIₙ=Σⱼ₌₀F(t)·sin (ωt)·S_{j,n}, (2)

SQₙ=Σⱼ₌₀F(t)·cos (ωt)·S_{j,n}, (3)

where SIₙ=sum of the demodulated I components of sense signals S_{j,n} for the nth drive step of the panel scan, SQₙ=sum of the demodulated Q components of sense signals S_{j,n} for the nth drive step of the panel scan, ω=stimulation signal frequency, and F(t)=window function of the demodulation waveforms sin(cot) and cos(cot). Examples of the window function F(t) can include a Hanning window, a Chebyshev window, a Hamming window, and the like. The lower the phase shift, the higher the I component and the lower the Q component. Conversely, the higher the phase shift, the lower the I component and the higher the Q component.

After the n drive steps of the panel scan have been completed, the resultants of the demodulated I and Q components can be calculated as follows (220).

IRᵢ=A⁻¹·SIₙ, (4)

QRᵢ=A⁻¹·SQₙ, (5)

where IRᵢ=I component resultant for the ith row in the touch panel, QRᵢ=Q component resultant for the ith row in the touch panel, and A⁻¹=inverse of stimulation matrix A. This can effectively isolate the I and Q components, i.e., the phase shifts, in the sense signals S.

Next, the magnitude of the touch signals R with little or no phase shift can be reconstructed from the I and Q resultants as follows (225).

RRᵢ=\sqrt{IRᵢ²+QRᵢ²}, (6)

where RRᵢ=reconstructed touch signal R for ith row in the touch panel. The square root of the squares of the I and Q resultants can be the magnitude of the touch signals R without the phase shifts. This can be likened to taking the square root of the squares of real and imaginary components of a complex number to get the magnitude of that complex number.

It is to be understood that the method is not limited to that described in FIG. 2, but can include other and/or additional actions to substantially reduce or eliminate phase shift in touch signals according to various embodiments. For example, in FIG. 2, rather than the demodulation (215) and calculation (220) being performed separately, they can be performed together.

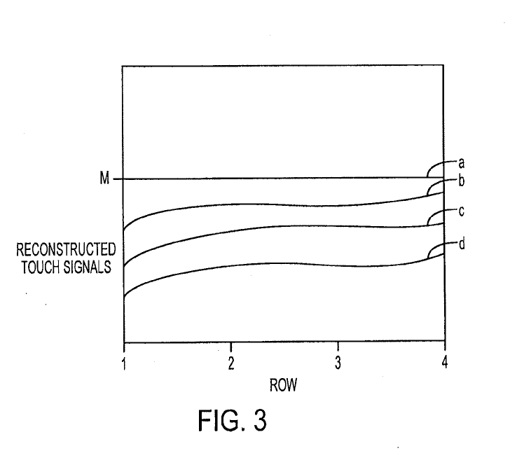

FIG. 3 illustrates the effects of various phase shifts on reconstructed touch signals. In the example of FIG. 3, the x-axis indicates the rows of the panel and the y-axis illustrates the magnitude of the reconstructed touch signals RR. Suppose that the original touch signals R have a magnitude M. In the figure, graph a represents reconstructed touch signals RR where the original touch signals R had no phase shifts, such that the magnitudes of the reconstructed signals RR on each row are M, the same as those of the original touch signals R. Graph b represents reconstructed touch signals RR with moderate phase shifts in the original touch signals R. Without applying a phase shift reduction method, as in FIG. 2, the reconstructed touch signals RR have magnitudes less the M. Graph c represented reconstructed touch signals RR with higher phase shifts and Graph d with high phase shifts in the original touch signals R. Without applying a phase reduction method, as in FIG. 2, the resulting magnitudes are farther and farther away from M.

As described previously, the method of FIG. 2 can substantially reduce or eliminate the phase shifts, such that the reconstructed touch signals RR can look like graph a, not graphs b-d.

In additional to correcting phase shifts in touch signals, various embodiments can be used to correct phase shifts and other effects in other applications. For examples, device signals can be captured, where the signals have phase shifts or other phase effects. The I and Q components of the captured signals can be calculated. The I and Q components can then be combined to reduce the phase shift or other phase effects in the captured signals.

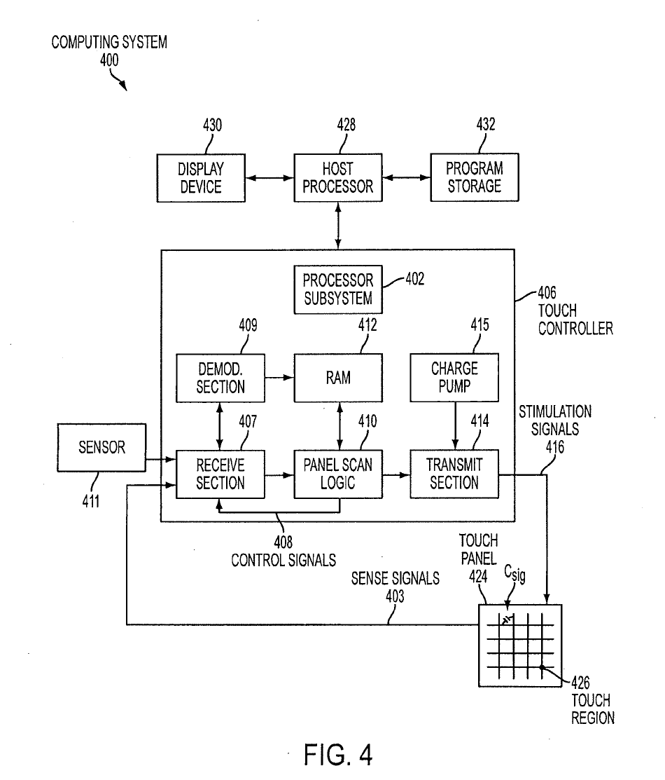

FIG. 4 illustrates an exemplary computing system 400 that can reduce phase shifts in touch signals according to various embodiments. In the example of FIG. 4, computing system 400 can include touch controller 406. The touch controller 406 can be a single application specific integrated circuit (ASIC) that can include one or more processor subsystems 402, which can include one or more main processors, such as ARM968 processors or other processors with similar functionality and capabilities. However, in other embodiments, the processor functionality can be implemented instead by dedicated logic, such as a state machine. The processor subsystems 402 can also include peripherals (not shown) such as random access memory (RAM) or other types of memory or storage, watchdog timers and the like. The touch controller 406 can also include receive section 407 for receiving signals, such as touch signals 403 of one or more sense channels (not shown), other signals from other sensors such as sensor 411, etc. The touch controller 406 can also include demodulation section 409 such as a multistage vector demodulation engine, panel scan logic 410, and transmit section 414 for transmitting stimulation signals 416 to touch panel 424 to drive the panel. The panel scan logic 410 can access RAM 412, autonomously read data from the sense channels, and provide control for the sense channels. In addition, the panel scan logic 410 can control the transmit section 414 to generate the stimulation signals 416 at various frequencies and phases that can be selectively applied to rows of the touch panel 424.

The touch controller 406 can also include charge pump 415, which can be used to generate the supply voltage for the transmit section 414. The stimulation signals 416 can have amplitudes higher than the maximum voltage by cascading two charge store devices, e.g., capacitors, together to form the charge pump 415. Therefore, the stimulus voltage can be higher (e.g., 6V) than the voltage level a single capacitor can handle (e.g., 3.6 V). Although FIG. 4 shows the charge pump 415 separate from the transmit section 414, the charge pump can be part of the transmit section.

Touch panel 424 can include a capacitive sensing medium having drive and sense lines according to various embodiments. The drive and sense lines can be formed from a transparent conductive medium such as Indium Tin Oxide (ITO) or Antimony Tin Oxide (ATO), although other transparent and non-transparent materials such as copper can also be used. The drive and sense lines can be formed on a single side of a substantially transparent substrate separated by a substantially transparent dielectric material, on opposite sides of the substrate, on two separate substrates separated by the dielectric material, etc.

Computing system 400 can also include host processor 428 for receiving outputs from the processor subsystems 402 and performing actions based on the outputs that can include, but are not limited to, moving an object such as a cursor or pointer, scrolling or panning, adjusting control settings, opening a file or document, viewing a menu, making a selection, executing instructions, operating a peripheral device coupled to the host device, answering a telephone call, placing a telephone call, terminating a telephone call, changing the volume or audio settings, storing information related to telephone communications such as addresses, frequently dialed numbers, received calls, missed calls, logging onto a computer or a computer network, permitting authorized individuals access to restricted areas of the computer or computer network, loading a user profile associated with a user's preferred arrangement of the computer desktop, permitting access to web content, launching a particular program, encrypting or decoding a message, and/or the like. The host processor 428 can also perform additional functions that may not be related to panel processing, and can be coupled to program storage 432 and display device 430 such as an LCD display for providing a UI to a user of the device. In some embodiments, the host processor 428 can be a separate component from the touch controller 406, as shown. In other embodiments, the host processor 428 can be included as part of the touch controller 406. In still other embodiments, the functions of the host processor 428 can be performed by the processor subsystem 402 and/or distributed among other components of the touch controller 406. The display device 430 together with the touch panel 424, when located partially or entirely under the touch panel or when integrated with the touch panel, can form a touch sensitive device such as a touch screen.

Note that one or more of the functions described above can be performed, for example, by firmware stored in memory (e.g., one of the peripherals) and executed by the processor subsystem 402, or stored in the program storage 432 and executed by the host processor 428. The firmware can also be stored and/or transported within any non-transitory computer readable storage medium for use by or in connection with an instruction execution system, apparatus, or device, such as a computer-based system, processor-containing system, or other system that can fetch the instructions from the instruction execution system, apparatus, or device and execute the instructions. In the context of this document, a “non-transitory computer readable storage medium” can be any non-transitory medium that can contain or store the program for use by or in connection with the instruction execution system, apparatus, or device. The non-transitory computer readable storage medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The firmware can also be propagated within any transport medium for use by or in connection with an instruction execution system, apparatus, or device, such as a computer-based system, processor-containing system, or other system that can fetch the instructions from the instruction execution system, apparatus, or device and execute the instructions. In the context of this document, a “transport medium” can be any non-transitory medium that can communicate, propagate or transport the program for use by or in connection with the instruction execution system, apparatus, or device. The transport medium can include, but is not limited to, an electronic, magnetic, optical, electromagnetic or infrared wired or wireless propagation medium.

It is to be understood that the touch panel is not limited to touch, as described in FIG. 4, but can be a proximity panel or any other panel according to various embodiments. In addition, the touch panel described herein can be either a single-touch or a multi-touch panel.

It is further to be understood that the computing system is not limited to the components and configuration of FIG. 4, but can include other and/or additional components in various configurations capable of reducing phase shifts in touch signals according to various embodiments.

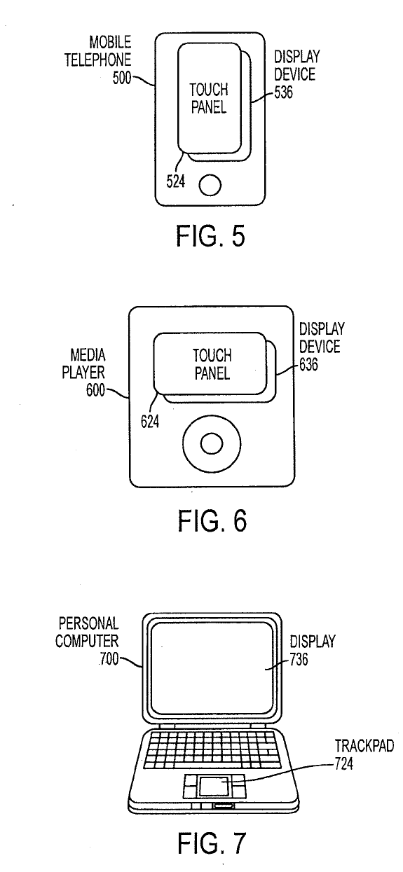

FIG. 5 illustrates an exemplary mobile telephone 500 that can include touch panel 524, display 536, and other computing system blocks, capable of reducing phase shifts in touch signals according to various embodiments.

FIG. 6 illustrates an exemplary digital media player 600 that can include touch panel 624, display 636, and other computing system blocks, capable of reducing phase shifts in touch signals according to various embodiments.

FIG. 7 illustrates an exemplary personal computer 700 that can include touch panel (trackpad) 724, display 736, and other computing system blocks, capable of reducing phase shifts in touch signals according to various embodiments.

The mobile telephone, media player, and personal computer of FIGS. 5 through 7 can realize improved accuracy and operation by reducing phase shifts in touch signals according to various embodiments.

Although embodiments have been fully described with reference to the accompanying drawings, it is to be noted that various changes and modifications will become apparent to those skilled in the art. Such changes and modifications are to be understood as being included within the scope of the various embodiments as defined by the appended claims.

What is claimed is:

1. A method for reducing phase shifts in a touch image, comprising:
generating an in-phase (I) signal for the touch image, the touch image having multiple phase shifts therein;
generating a quadrature phase (Q) signal for the touch image;
combining the I and Q signals to reduce the phase shifts; and
reconstructing the touch image from the combined I and Q signals.

2. The method of claim 1, wherein generating an I signal comprises demodulating the touch image with a demodulation waveform and a window function.

3. The method of claim 2, wherein the demodulation waveform is a sine waveform.

4. The method of claim 2, wherein the window function is at least one of a Hanning window, a Chebyshev window, or a Hamming window.

5. The method of claim 1, wherein generating a Q signal comprises demodulating the touch image with a demodulation waveform and a window function.

6. The method of claim 5, wherein the demodulation waveform is a cosine waveform.

7. The method of claim 1, wherein combining the I and Q signals comprises:
isolating the I and Q signals from the touch image; and
calculating the square root of the sum of the squares of the isolated I and Q signals.

8. The method of claim 7, wherein isolating the I and Q signals comprises applying an inverse of a stimulation matrix to the touch image to isolate the I and Q signals, the stimulation matrix including data for generating the touch image.

9. The method of claim 1, wherein combining the I and Q signals comprises calculating a magnitude of the I and Q signals and excluding a phase of the I and Q signals.

10. The method of claim 1, wherein reconstructing the touch image comprises setting the combined I and Q signals as the reconstructed touch image.

11. A method for reducing phase shifts in a signal, comprising:
capturing a signal with a phase shift;
calculating in-phase (I) and quadrature phase (Q) components of the signal; and
combining the I and Q components so as to reduce the phase shift in the signal.

12. The method of claim 11, wherein capturing a signal comprises:
applying stimulation signals to a device; and
generating the signal as a function of the applied stimulation signals, the signal including a phase shift.

13. The method of claim 12, wherein applying stimulation signals comprises accessing a stimulation matrix, the stimulation matrix defining a pattern for applying the stimulation signals.

14. The method of claim 13, wherein calculating I and Q components comprises applying an inverse of the stimulation matrix to the signal to calculate the I and Q components.

15. The method of claim 11, comprising reconstructing the signal with the combined I and Q components, the reconstructed signal having little or no phase shift.

16. A touch sensitive device comprising:
a touch panel for capturing a touch image with phase shifts;
scan logic for stimulating the touch panel to capture the touch image; and
a processor for reducing phase shifts in the touch image, the processor capable of:
calculating in-phase (I) and quadrature phase (Q) components of the touch image, and
reconstructing the touch image with reduced phase shifts based on the combined I and Q components, wherein the combined I and Q components include magnitude information of the touch image and exclude phase information of the touch image.

17. The device of claim 16, wherein the scan logic stimulates the touch panel with multiple stimulation signals concurrently for capturing the touch image.

18. The device of claim 16, wherein the scan logic stimulates the touch panel with single stimulation signals in sequence for capturing the touch image.

19. The device of claim 16 comprising at least one of a computer, a media player, or a mobile telephone.

20. A system for reducing phase shifts in touch signals, comprising:
a touch panel having multiple touch regions capable of generating the touch signals indicative of a proximate object, the touch regions including resistive components to introduce the phase shifts into the touch signals; and
a processor capable of reducing the phase shifts in the generated touch signals based on a combination of an in-phase (I) component of the touch signals and a quadrature phase (Q) component of the touch signals.

21. The system of claim 20, comprising drive circuitry capable of driving the touch panel with stimulation signals to generate the touch signals, the resistive components interfering with at least one of the stimulation signals or the touch signals to cause the phase shifts in the touch signals.

22. The system of claim 21, wherein one or more of the touch signals has a different phase shift.

23. The system of claim 20, comprising sense circuitry capable of receiving the generated touch signals.

24. The system of claim 20, wherein the phase shifts are proportional to the Q component and inversely proportional to the I component.
